(19) United States
(12) Patent Application Publication
(10) Pub. No.: US 2024/0311640 A1
(43) Pub. Date: Sep. 19, 2024

(54) DEVICE AND METHOD FOR IMPROVED POLICY LEARNING FOR ROBOTS

(71) Applicants: Robert Bosch GmbH, Stuttgart (DE); Carnegie Mellon University, Pittsburgh, PA (US)

(72) Inventors: Felix Berkenkamp, Muenchen (DE); Gaurav Manek, Pittsburgh, PA (US); Jeremy Zieg Kolter, Pittsburgh, PA (US); Melrose Roderick, Pittsburgh, PA (US)

(21) Appl. No.: 18/589,910

(22) Filed: Feb. 28, 2024

(30) Foreign Application Priority Data
Mar. 16, 2023 (DE) 10 2023 202 409.8

(51) Int. Cl. G06N 3/092

(52) U.S. Cl. CPC G06N 3/092

(57) ABSTRACT

A computer-implemented method of learning a policy for an agent. The method includes: receiving an initialized first neural network, in particular a Q-functionor value-function, an initialized second neural network, auxiliary parameters, and the initialized policy; repeating the following steps until a termination condition is fulfilled: sampling a plurality of pairs of states, actions, rewards and new states from a storage. Sampling actions for the current states, and actions for the new sampled states; computing features from a penultimate layer of the first neural network based on the sampled states and actions and updating the second neural network and the auxiliary parameters as well as updating parameters the first neural network using a re-weighted loss.

### CROSS REFERENCE

The present application claims the benefit under 35 U.S.C. § 119 of German Patent Application No. DE 10 2023 202 409.8 filed on Mar. 16, 2023, which is expressly incorporated herein by reference in its entirety.

### FIELD

The present invention concerns a method for learning a policy, a computer program and a machine-readable storage medium, a system carrying out said method.

### BACKGROUND INFORMATION

Reinforcement Learning (RL) aims to learn policies that maximize rewards in Markov Decision Processes (MDPs) through interaction, generally using Temporal Difference (TD) methods. In contrast, offline RL focuses on learning optimal policies from a static dataset sampled from an unknown policy, possibly a policy designed for a different task. Thus, algorithms are expected to learn without the ability to interact with the environment. This is useful in environments that are expensive to explore.

Nearly all modern TD-based deep RL methods perform off-policy learning in practice. To improve data efficiency and learning stability, an experience replay buffer is often used. This buffer stores samples from an outdated version of the policy. Additionally, exploration policies, such as epsilon greedy or Soft Actor Critic (SAC)-style entropy regularization, are often used, which also results in off-policy learning. In practice, the difference between the current policy and the samples in the buffer is limited by setting a limit to the buffer size and discarding old data; or by keeping the exploration policy relatively close to the learned policy.

However, in the offline RL setting where training data is static, there is usually a much larger discrepancy between the state-action distribution of the data and the distribution induced by the learned policy. This discrepancy presents a significant challenge for offline RL. While this distributional discrepancy is often presented as a single challenge for offline RL algorithms, there are two distinct aspects of this challenge that can be addressed independently: support mismatch and proportional mismatch. When the support of the two distributions differs, learned value functions will have arbitrarily high errors in low-data regions. Support mismatch is dealt with by either constraining the KL-divergence between the data and learned policies, by penalizing or pruning low support (or high-uncertainty) actions.

Even when the support of the data distribution matches that of the policy distribution, naive TD methods can produce unbounded errors in the value function. This challenge can be referred to as proportional mismatch. Importance sampling (IS) is one of the most widely used techniques to address proportional mismatch. The idea with IS is to compute the differences between the data and policy distributions for every state-action pair and re-weight the TD updates accordingly. However, these methods suffer from variance that grows exponentially in the trajectory length. Several methods have been proposed to mitigate this challenge and improve performance of IS in practice, but the learning is still far less stable than other offline deep RL methods.

Thus, a key problem in offline Reinforcement Learning (RL) is the mismatch between the dataset and the distribution over states and actions visited by the learned policy, called the distribution shift. This is typically addressed by constraining the learned policy to be close to the data generating policy, at the cost of performance of the learned policy.

Therefore, there is a desire to improve offline RL with respect to the distribution shift.

### SUMMARY

According to an example embodiment of the present invention, it is provided to use a critic update rule that resamples TD updates to allow the learned policy to be distant from the data policy without catastrophic divergence. In particular, according to an example embodiment of the present invention, an optimization problem is disclosed to reweight the replay-buffer distribution with weights that are close to the replay-buffer distribution. This modified critic update rule enables reinforcement learning algorithms to move further away from the data without causing instabilities or divergence during learning.

Furthermore, this modified critic update rule may additionally provide an advantage of computing a “safe” sampling distribution that satisfies the Non-Expansion Criterion (NEC), a theoretical condition under which off-policy learning is stable.

In a first aspect, the present invention concerns a computer-implemented method for learning a policy for an agent, in particular an at least partly autonomous robot. A policy can be configured to output an action depending on a current state. If following the proposed actions by the policy, a goal, for which the policy has been optimized by offline reinforcement learning, will be achieved.

According to an example embodiment of the present invention, the method starts with a step of receiving an initialized first neural network, that either calculates a Q-function Q_{(θ}_{^{q}}₎ or a value-function of RL, wherein the first neural network is parametrized by θ^{Q} or θ^{V} respectively, an initialized second neural network, which calculates a function g_{(θ}_{^{q}}₎, wherein the first neural network is parametrized by θ^{g}, auxililary parameters (A, B), and the initialized policy (π).

It is noted that the exact structure of the policy (π) is not important, since the method for learning the value function uses data directly. For deterministic policies the expected value is equal to the of the corresponding outputted action. Possible policies structures can be: Neural networks (MLP), often as last layer a sigmoid or tanh to restrict the outputs to a valid space. The network can also output the statistics of a probability distribution from which the actions are then sampled. E.g. mean and standard deviation for a Gaussian distribution. The policy can also consist of any classical controller applied to a system (for example an automotive controller, e.g. ABS).

Then, the following steps are repeated as a loop until a termination condition (e.g. a predefined number of iteration) is fulfilled:

The loop starts with a sampling a plurality of pairs (s,a,r, s′) of states, actions, rewards and new states from a storage. The plurality of pairs can be referred to as batch of pairs. Preferably, the batch is a mini batch. The states, actions, rewards and new states of a pair belong to each other, meaning that for a given state of the pairs, the corresponding action of said pair is selected by an exploration policy and by carrying out the corresponding action, the reward and new state are obtained.

Next in the loop is a step of sampling actions ã˜π_{(θ)}(s) for the current states, and actions ã′π_{(θ)}(s′) for the new sampled states.

Next in the loop is a step of computing features ϕ←Q_{θ}_{^{Q}}(s, a), ϕ′←Q_{θ}_{^{Q}}(s′, ã′) from a penultimate layer of the first neural network based on the sampled states and actions.

Next in the loop is a step of updating the second neural network (g_{(θ}_{^{g}}₎) and the auxililary parameters (A, B) as follows:

$${θ}_{t}^{g} ← {θ}_{t - 1}^{g} - {η}_{g} {∇}_{{θ}^{g}} {L}_{g} ( s , {s}^{′} )$$

$${A}_{t} ← {A}_{t - 1} - {η}_{A} {∇}_{A} {L}_{A , B} ( s , {s}^{′} )$$

$${B}_{t} ← {B}_{t - 1} - {η}_{B} {∇}_{B} {L}_{A , B} ( s , {s}^{′} )$$

It is noted that the equations are exemplarily given for the value function, but the equations are analogously applicable for the Q-function by adding dependencies of a, a′ to the equations accordingly.

Next in the loop is a step of updating parameters (θ^{Q}) the first neural network using a re-weighted L_{Q} loss by an exponential function applied on the output of second neural network. The loss (L_{Q}) can be a Bellman loss. The updating can be carried out as follows:

$${θ}_{t}^{Q} ← {θ}_{t - 1}^{Q} - {η}_{Q} exp ( {g}_{{θ}^{g}} ( s , a ) ) {∇}_{{θ}^{Q}} {L}_{Q} ( {θ}^{Q} )$$

For mini batches, the loss (L_{Q}) is either averaged over the batch or a sum of the losses of the batch.

Finally, the loop ends with a step of updating parameters (θ^{π}) of the policy as follows:

$${θ}_{t}^{π} ← {θ}_{t - 1}^{π} - {η}_{π} {∇}_{π} [ {Q}_{{θ}^{Q}} ( s , \tilde{a} ) - log {π}_{{θ}^{π}} ( \tilde{a} \vert s ) ]$$

It is noted that any policy update method based on a critic can be applied to update the policy. E.g. one could omit or weight the logπ_{θ}_{^{π}} term. There are also other methods that use the critic differently. Thus, any Actor-Critic methods can be utilized for the step of updating the policy. Actor-Critic methods are temporal difference (TD) learning methods that represent the policy function independent of the value function. In the Actor-Critic method, the policy is referred to as the actor that proposes a set of possible actions given a state, and the estimated value function is referred to as the critic, which evaluates actions taken by the actor based on the given policy.

The method according to the present invention may have an advantage that the trained policy is more robust and precise and thus can be used for more reliable control a physical system and in particular operating the physical system according to the outputted actions of the policy.

According to an example embodiment of the present invention, it is provided that COL regularization is utilized for updating of the first neural network This provides the advantage of preventing over-optimism on low-support regions of the state-action space. For more details about COL, see Aviral Kumar et al. “Conservative Q-Learning for Offline Reinforcement Learning”. 1357 In: Advances in Neural Information Processing Systems 33: Annual Conference on 1358 Neural Information Processing Systems 2020, NeurIPS 2020 December 6-12, 2020, 1359 virtual. Ed. by Hugo Larochelle et al. 2020. https://proceedings.neurips.1360cc/paper/2020/hash/0d2b2061826a5df3221116a5085a6052-Abstract.html.

The determined action of the policy can be utilized to provide a control signal for controlling an actor of the agent, comprising all the steps of the above method for controlling the robot and further comprising the step of: Determining said actuator control signal depending on said output signal. Preferably said actuator controls at least a partially autonomous robot and/or a manufacturing machine and/or an access control system.

It is noted that the policy can be learned for controlling dynamics and/or stability of the agent. The policy can receive as input sensor values characterizing the state of the agent and/or the environment. The policy is trained to following an optimal trajectory. The policy outputs values characterizing control values such that the agent would follow the optimal trajectory.

Example embodiments of the present invention will be discussed with reference to the following figures in more detail.

### BRIEF DESCRIPTION OF THE DRAWINGS

FIG. 1 shows a flow-chart diagram of a method according to an example embodiment of the present invention.

FIG. 2 shows a control system having a classifier controlling an actuator in its environment, according to an example embodiment of the present invention.

FIG. 3 shows the control system controlling an at least partially autonomous robot, according to an example embodiment of the present invention.

FIG. 4 shows the control system controlling a manufacturing machine, according to an example embodiment of the present invention.

FIG. 5 shows the control system controlling an automated personal assistant, according to an example embodiment of the present invention.

FIG. 6 shows the control system controlling an access control system, according to an example embodiment of the present invention.

FIG. 7 shows the control system controlling a surveillance system, according to an example embodiment of the present invention.

FIG. 8 shows the control system controlling an imaging system, according to an example embodiment of the present invention.

### DETAILED DESCRIPTION OF EXAMPLE EMBODIMENTS

In reinforcement learning, we typically have a policy π that given a current observation of the system, s, defines a distribution over actions to take on the system, a˜π_{θ}(s). After taking this action, the system transitions to a new state, s′. The goal is to maximize the discounted sum of a corresponding reward signal r. To do this, most reinforcement learning rely on actor-critic algorithms that first learn a function (a critic) that determines the quality of actions and consequently optimizes the policy by maximizing the values on its action.

This typically happens based on data in a replay buffer [symbol] ={(sₙ, aₙ, rₙ, sₙ′)}ₙ₌₁^{N}, which consists of recorded transitions from states sₙ with applied actions aₙ to next states sₙ′ together with a corresponding step reward rₙ. Based on this dataset, a common way to optimize a policy π is by maximizing the objective, for example, a common choice is:

$${max}_{π} {E}_{a ∼ {π}_{θ} ( s )} [ Q ( s , a ) ] \qquad ( eq . 1 )$$

where Q(s, a) is the corresponding critic, which approximates the cumulative reward when taking action a in state s and then sampling subsequent actions from π. The key ingredient that determines the performance of reinforcement learning is the quality of the Q-function, which needs to be learned from data.

The most common way to learn a critic is via temporal-difference learning, which minimizes the Bellman error

$${min}_{Q} {ℒ}_{Q}$$

to train a Q function:

$${ℒ}_{𝒬} ( s , a , {s}^{′} , {a}^{′} ) = {( Q ( s , a ) - ( r + γ Q ( {s}^{′} , {a}^{′} ) ) )}^{2} \qquad ( eq . 2 )$$

We optimize this objective through:

$${min}_{Q} {E}_{( s , a , r , {s}^{′} ) ∼ 𝒟 , {a}^{′} ∼ π ( {s}^{′} )} {ℒ}_{𝒬} ( s , a , {s}^{′} , {a}^{′} ) \qquad ( eq . 3 )$$

which samples transitions from the dataset [symbol] and then samples a corresponding next action a′ from the policy, where E represents the expectation. This is known to diverge under significant differences between the data and policy distributions. Note that the squared loss is a typical choice, but other loss functions are possible too.

Similarly value functions can be learned through the objective:

$${ℒ}_{𝒱} ( s , {s}^{′} ) = {( V ( s ) - ( r + γ V ( {s}^{′} ) ) )}^{2} \qquad ( eq . 4 )$$

which suffer the same issue with off-policy data.

In the following, some words to the mathematical background of the present invention shall be spoken. As mentioned in the description below, we want to re-weight the data-based loss function to stabilize learning. That is, nominally we would optimize a loss function over the empirical data distribution: [symbol] [symbol] , which we refer to as μ in the following. Reweighting this loss is equivalent to finding a new distribution q over the dataset [symbol] and optimize E_{(s,a,r,s′)˜q}

[symbol]

We aim to find a distribution q that is a close as possible to the data-distribution μ, while satisfying a theoretical condition under which learning is stable, see reference: https://proceedings.neurips.cc/paper/2011/hash/fe2d010308a6b3799a3d9c728ee74244-Abstract.html, in particular equation (13) and Theorem 2. In particular, we solve the optimization problem

$$\text{?} KL ( q ‖ μ ) subject to : \text{?} [ F ( s , a ) ] \text{?} 0$$

$$where$$

$$F ( s , a ) = \text{?} [ \begin{matrix}ϕ ( s , a ) {ϕ ( s , a )}^{T} & ϕ ( s , a ) {ϕ ( {s}^{′} , {a}^{′} )}^{T} \\ ϕ ( {s}^{′} , {a}^{′} ) {ϕ ( s , a )}^{T} & ϕ ( s , a ) {ϕ ( s , a )}^{T}\end{matrix} ]$$

$$\text{?} \text{indicates text missing or illegible when filed}$$

and X≥0 means that the matrix X needs to be positive semi-definite. The operator ϕ is a mapping function, which is used for calculating the Q-function.

The constraint is a theoretical condition that ensures stable learning and depends on the expectation over the true environment transitions p. This optimization problem is intractable in general, but we approximate it in the following to obtain a practical algorithm. It is noted that the approximation is conducted by formulating the dual problem and utilizing Lagrange multiplier. For the sake of clarity, the explicit derivation of the dual problem is omitted. The mathematical results provided below result from the reformulation of the dual problem with Lagrange multiplier.

In the following, a detailed discussion of a mathematical description of the present invention is provided.

We re-weight the TD-targets by a weighting factor exp(g_{θ}(s, a)), where g_{θ} can be a learned neural network. Consequently, the TD update in (eq.2) changes to:

$${ℒ}_{𝒬 , pop} ( s , a , {s}^{′} , {a}^{′} ) = exp ( {g}_{θ} ( s , a ) ) {ℒ}_{𝒬} ( s , a , {s}^{′} , {a}^{′} ) \qquad ( eq . 7 )$$

For value functions, we obtain the equivalent of (eq. 4), but with a weighting factor exp(g_{θ}(s)) that is independent of the action. We focus on the Q-function equations in the following, but the teaching is analogously applicable for the value function.

Due to the re-weight, it is possible to determine a weighting factor that ensures stable learning. Concretely, we approximately solve a theoretical condition for stability and find the weights closest to uniform weighting. For this, we consider Q functions that are linear in features ϕ(s, a)∈R^{k}, so that Q(s, a)=w^{τ}ϕ(s, a). Neural networks fall into this description, where ϕ(s, a) represents the network structure and w are the weights of the final, linear layer without any output activations. The parameters θ^{Q} of Q consists of both the weights w and the parameters in ϕ (all previous layers).

In particular, we introduce auxiliary parameters A, B∈R^{k,m}, where 0<m≤k is a given size that will typically be picked manually. It is noted that these auxiliary parameters originate from the Lagrange multiplier. We learn these parameters jointly with g_{θ}. In particular, we define the auxiliary loss functions for them as follows:

$${ℒ}_{A , B} = \text{?} \text{} exp ( \text{} \text{?} \text{} ( s , a ) ) \text{} ( {‖ {( A + B )}^{T} ϕ ( s ) ‖}_{2}^{2} - trace ( 2 {B}^{T} ϕ ( s , a ) {( ϕ ( s , a ) - ϕ ( {s}^{′} , {a}^{′} ) )}^{T} A ) ) \qquad ( 8 )$$

$${ℒ}_{θ} = \text{?} \text{} ( \text{?} \text{} ( s , \text{} a ) - [ \text{} {‖ {( A + B )}^{T} ϕ ( s ) ‖}_{2}^{2} - trace ( 2 {B}^{T} [ ϕ ( s , a ) ( ϕ ( s , a ) - ϕ ( {s}^{′} , {a}^{′} ) ) ] ) ] \text{?} \qquad ( 9 )$$

$$\text{?} \text{indicates text missing or illegible when filed}$$

We optimize these equations jointly together with the Q-function in (eq. 7). The corresponding equations for the value function as the same, with a and a′ dropped from the feature vectors and function g: ϕ(s, a)→ϕ(s), ϕ(s′, a′)→ϕ(s′), and g_{θ}(s, a)→g_{θ}(s).

Subsequently, our combined learning objective is [symbol] =L_{Q,pop}+ [symbol] + [symbol] , which we optimize through

$${min}_{Q , A , B , θ} \text{?} {ℒ}_{pop} ( s , a , {s}^{′} , {a}^{′} ) \qquad ( eq . 10 )$$

$$\text{?} \text{indicates text missing or illegible when filed}$$

Thus, the weighting factor as well as the auxiliary parameters are jointly optimized. This optimization can be a two-timescales approach that estimates two (dependent) quantities separately and improving them at potentially different rates.

The losses can be computed more efficiently (avoid repeated computation) as follows:

$${M}_{A} = {A}^{T} ϕ ( s , a ) \qquad ( eq . 11 )$$

$${M}_{A}^{′} = {A}^{T} ϕ ( {s}^{′} , {a}^{′} )$$

$${M}_{B} = {B}^{T} ϕ ( s )$$

$${ℒ}_{A , B} = \text{?} exp ( \text{?} ( s , a ) ) ( {‖ {M}_{A} ‖}_{2}^{2} + {‖ {M}_{B} ‖}_{2}^{2} + 2 {M}_{B}^{T} {M}_{A}^{′} )$$

$${ℒ}_{g} = \text{?} {( \text{?} ( s , a ) - [ {‖ {M}_{A} ‖}_{2}^{2} + {‖ {M}_{B} ‖}_{2}^{2} + 2 {M}_{B}^{T} {M}_{A}^{′} ] )}^{2}$$

$$\text{?} \text{indicates text missing or illegible when filed}$$

which is O(mk) instead of the O(mk²) complexity of a naive implementation.

The parameter m is a free design parameter. It can generally be picked by hand to be “large enough”. The minimal size depends on the vectors ϕ, where we need: m≥2k−rank(F)

where

$$F = \text{?} [ \begin{matrix}ϕ ( s , a ) {ϕ ( s , a )}^{T} & ϕ ( s , a ) {ϕ ( {s}^{′} , {a}^{′} )}^{T} \\ ϕ ( {s}^{′} , {a}^{′} ) {ϕ ( s , a )}^{T} & ϕ ( s , a ) {ϕ ( s , a )}^{T}\end{matrix} ]$$

$$\text{?} \text{indicates text missing or illegible when filed}$$

However, this is typically too expensive to compute in practice.

The updating rule of the parameters θ^{Q} for the Q-function is carried out by gradient descent. It is noted that due to eq. 7 [symbol] (s, a, s′, a′) the weighing factor is implicitly considered by calculating the gradient due to the factor rule when deriving the gradient. Thus, for updating of the parameters θ^{Q} according to gradient descent, no further modifications are necessary.

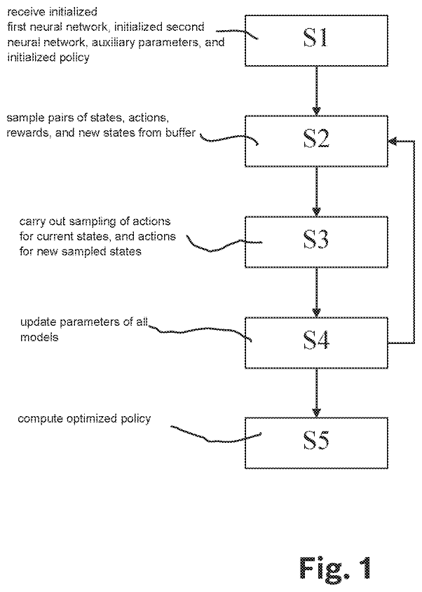

Shown in FIG. 1 is a flow-chart diagram of an embodiment of the method for learning a policy for controlling an agent, in particular a robot.

The method starts with a step of receiving (S1) an initialized first neural network, an initialized second neural network (g_{(θ}_{^{g}}₎), auxililary parameters (A, B), and the initialized policy (π). The first neural network is suited for calculating the a Q-function (Q_{(θ}_{^{q}}₎) or value-function.

Afterwards, subsequent steps are repeated until a termination condition is fulfilled. The termination condition can be a predefined number of iterations.

In step, a plurality of pairs (s,a,r,s′) of states, actions, rewards and new states from the buffer are sampled (S2).

In the next step, a sampling (S3) of actions (ã˜π_{(θ)}(s)) for the current states, and actions (ã′˜π_{(θ)}(s′)) for the new sampled states is carried out. Preferably, the policy π_{(θ)} outputs probabilities for each possible action and depending on the probabilities the actions (ã) is selected. The term sampling implies that the policy outputs a probability distribution (e.g. a Gaussian distribution) from which we then sample the actions. In the literature there is the distinction “deterministic policy” and “stochastic policy”, where the deterministic one is a special interval of the stochastic one (a Dirac-Delta distribution which puts probability mass only on one action).

In the next step, the parameters of all models are updated (S4).

The updating starts with computing features (ϕ←Q_{θ}_{^{Q}}(s, a), ϕ′←Q_{θ}_{^{Q}}(s′,ã′)) from a penultimate layer of the first neural network based on the sampled states and actions.

Based on the features (ϕ), the second neural network (g_{(θ}_{^{g}}₎) and the auxililary parameters (A, B) are updated. This can be done utilizing eq.8,9 or 11:

$${θ}_{t}^{g} ← {θ}_{t - 1}^{g} - {η}_{g} {∇}_{{θ}^{g}} {L}_{g} ( s , {s}^{′} , a , {a}^{′} )$$

$${A}_{t} ← {A}_{t - 1} - {η}_{A} {∇}_{A} {L}_{A , B} ( s , {s}^{′} , a , {a}^{′} )$$

$${B}_{t} ← {B}_{t - 1} - {η}_{B} {∇}_{B} {L}_{A , B} ( s , {s}^{′} , a , {a}^{′} )$$

Subsequently, parameters (θ^{Q}) of the first neural network are updated using a re-weighted loss (L_{Q}) by the second neural network:

$${θ}_{t}^{Q} ← {θ}_{t - 1}^{Q} - {η}_{Q} exp ( {g}_{{θ}^{g}} ( s , a ) ) {∇}_{{θ}^{Q}} {L}_{Q} ( {θ}^{Q} )$$

Finally, the parameters (θ^{π}) of the policy are updated as follows:

$${θ}_{t}^{π} ← {θ}_{t - 1}^{π} - {η}_{π} {∇}_{π} [ {Q}_{{θ}^{Q}} ( s , \tilde{a} ) - log {π}_{{θ}^{π}} ( \tilde{a} \vert s ) ]$$

The sequence of steps S2-S4 is carried out several times until the termination criterion is fulfilled.

If the loop of steps S2-S4 has been terminated, the resulting optimized policy can be used to compute (S5) a control signal for controlling a physical system, e.g., a computer-controlled machine, a robot, a vehicle, a domestic appliance, a power tool, a manufacturing machine, or an access control system. It does so by learning a policy for controlling the physical system and then operating the physical system accordingly. Generally speaking, a policy obtained as described above interacts with any kind of system. As such the range of application is extremely broad. In the following some applications are exemplarily described.

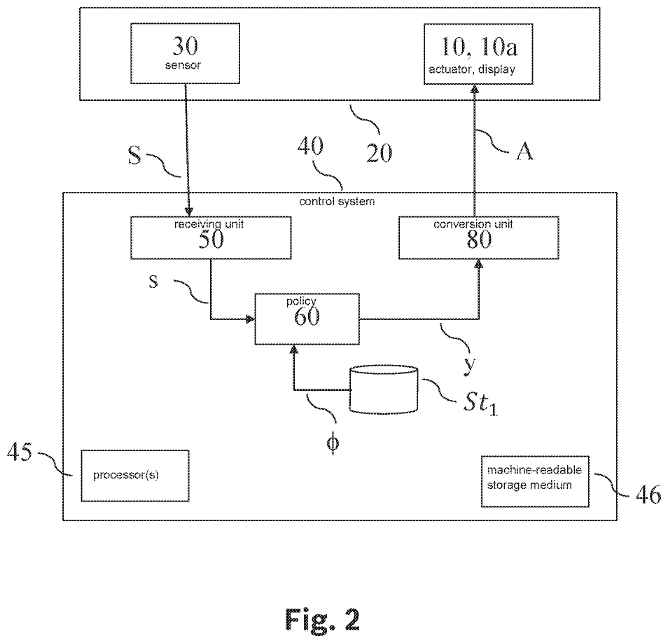

Shown in FIG. 2 is one embodiment of an actuator 10 in its environment 20. Actuator 10 interacts with a control system 40. Actuator 10 and its environment 20 will be jointly called actuator system. At preferably evenly spaced distances, a sensor 30 senses a condition of the actuator system. The sensor 30 may comprise several sensors. An output signal S of sensor 30 (or in case the sensor 30 comprises a plurality of sensors, an output signal S for each of the sensors) which encodes the sensed condition is transmitted to the control system 40. Possible sensors include but are not limited to gyroscopes, accelerometers, force sensors, cameras, radar, lidar, angle encoders, etc. Note that oftentimes sensors do not directly measure the state of the system but rather observe a consequence of the state, e.g., a camera detects an image instead of directly the relative position of a car to other traffic participants. However, it is possible to filter the state from high-dimensional observations like images or lidar measurements.

Thereby, control system 40 receives a stream of sensor signals S. It then computes a series of actuator control commands A depending on the stream of sensor signals S, which are then transmitted to actuator 10.

Control system 40 receives the stream of sensor signals S of sensor 30 in an optional receiving unit 50. Receiving unit 50 transforms the sensor signals S into states s. Alternatively, in case of no receiving unit 50, each sensor signal S may directly be taken as an input signal s.

Input signal s is then passed on to policy 60, which may, for example, be given by an artificial neural network.

Policy 60 is parametrized by parameters □, which are stored in and provided by parameter storage St₁.

Policy 60 determines output signals y from input signals s. The output signal y may be an action a. Output signals y are transmitted to an optional conversion unit 80, which converts the output signals y into the control commands A. Actuator control commands A are then transmitted to actuator 10 for controlling actuator 10 accordingly. Alternatively, output signals y may directly be taken as control commands A.

Actuator 10 receives actuator control commands A, is controlled accordingly and carries out an action corresponding to actuator control commands A. Actuator 10 may comprise a control logic which transforms actuator control command A into a further control command, which is then used to control actuator 10.

In further embodiments, control system 40 may comprise sensor 30. In even further embodiments, control system 40 alternatively or additionally may comprise actuator 10.

In one embodiment policy 60 may be designed signal for controlling a physical system, e.g., a computer-controlled machine, a robot, a vehicle, a domestic appliance, a power tool, a manufacturing machine, or an access control system. It does so by learning a policy for controlling the physical system and then operating the physical system accordingly.

In still further embodiments, it may be envisioned that control system 40 controls a display 10a instead of an actuator 10.

Furthermore, control system 40 may comprise a processor 45 (or a plurality of processors) and at least one machine-readable storage medium 46 on which instructions are stored which, if carried out, cause control system 40 to carry out a method according to one aspect of the present invention.

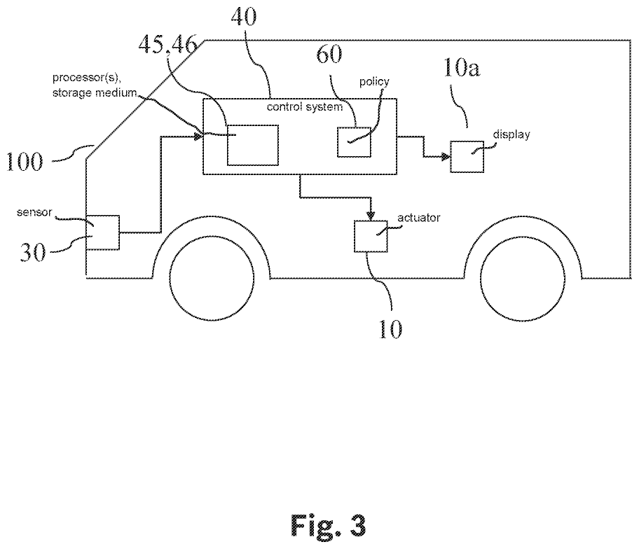

FIG. 3 shows an embodiment in which control system 40 is used to control an at least partially autonomous robot, e.g. an at least partially autonomous vehicle 100.

Sensor 30 may comprise one or more video sensors and/or one or more radar sensors and/or one or more ultrasonic sensors and/or one or more LiDAR sensors and or one or more position sensors (like e.g. GPS). Some or all these sensors are preferably but not necessarily integrated in vehicle 100.

Alternatively or additionally sensor 30 may comprise an information system for determining a state of the actuator system. One example for such an information system is a weather information system which determines a present or future state of the weather in environment 20.

For example, using input signal s, the policy 60 may for example control the at least partially autonomous robot to achieve a predefined goal state. Output signal y controls the at least partially autonomous robot.

Actuator 10, which is preferably integrated in vehicle 100, may be given by a brake, a propulsion system, an engine, a drivetrain, or a steering of vehicle 100. Preferably, actuator control commands A may be determined such that actuator (or actuators) 10 is/are controlled such that vehicle 100 avoids collisions with objects in the environment of the at least partially autonomous robot.

Preferably, the at least partially autonomous robot is an autonomous car. A possible description of the car's state can include its position, velocity, relative distance to other traffic participants, the friction coefficient of the road surface (can vary for different environments e.g. rain, snow, dry, etc.). Sensors that can measure this state include gyroscopes, angle encoders at the wheels, camera/lidar/radar, etc. The reward signal for this type of learning would characterize on how well a pre-computed trajectory, a.k.a. reference trajectory, is followed by the car. The reference trajectory can be determined by an optimal planner. Actions for this system can be a steering angle, brakes and/or gas. Preferably, the brake pressure or the steering angle is outputted by the policy, in particular such that a minimal braking distance is achieved or to carry out an evasion maneuver, as a (sub-) optimal planner would do it.

It is noted that for this embodiment, the policy can be learned for controlling dynamics and/or stability of the at least partially autonomous robot. For example if the robot is in a safety critical situation, the policy can control the robot to maneuver it out of said critical situation, e.g. by conducting an emergency break. The policy can then output a value characterizing a negative acceleration, wherein the actor is then controlled depending on said value, e.g. breaks with a force related to the negative acceleration.

In further embodiments, the at least partially autonomous robot may be given by another mobile robot (not shown), which may, for example, move by flying, swimming, diving or stepping. The mobile robot may, inter alia, be an at least partially autonomous lawn mower, or an at least partially autonomous cleaning robot.

In a further embodiment, the at least partially autonomous robot may be given by a gardening robot (not shown), which uses sensor 30, preferably an optical sensor, to determine a state of plants in the environment 20. Actuator 10 may be a nozzle for spraying chemicals. An actuator control command A may be determined to cause actuator 10 to spray the plants with a suitable quantity of suitable chemicals.

In even further embodiments, the at least partially autonomous robot may be given by a domestic appliance (not shown), like e.g. a washing machine, a stove, an oven, a microwave, or a dishwasher. Sensor 30, e.g. an optical sensor, may detect a state of an object which is to undergo processing by the household appliance. For example, in the case of the domestic appliance being a washing machine, sensor 30 may detect a state of the laundry inside the washing machine. Actuator control signal A may then be determined depending on a detected material of the laundry.

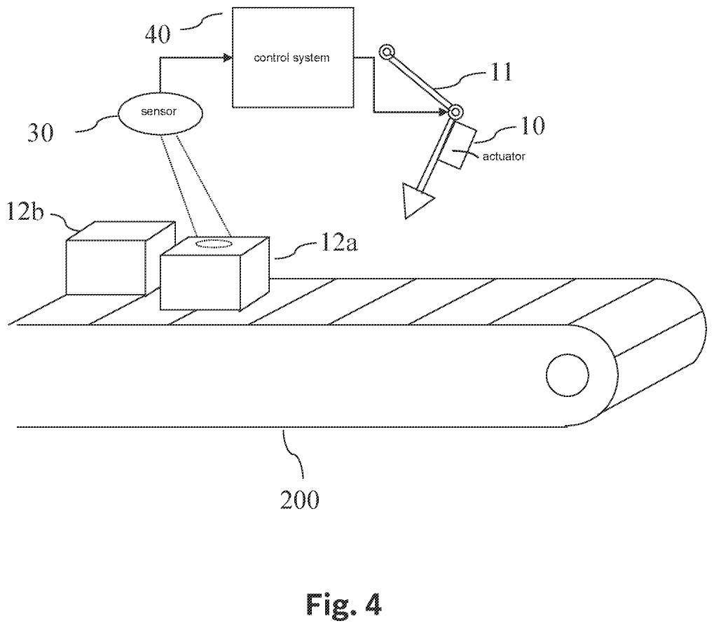

Shown in FIG. 4 is an embodiment in which control system 40 is used to control a manufacturing machine 11, e.g. a punch cutter, a cutter or a gun drill) of a manufacturing system 200, e.g. as part of a production line. The control system 40 controls an actuator 10 which in turn control the manufacturing machine 11.

Sensor 30 may be given by an optical sensor which captures properties of e.g. a manufactured product 12. Policy 60 may determine depending on a state of the manufactured product 12 an action to manipulate the product 12. Actuator 10 which controls manufacturing machine 11 may then be controlled depending on the determined state of the manufactured product 12 for a subsequent manufacturing step of manufactured product 12. Or it may be envisioned that actuator 10 is controlled during manufacturing of a subsequent manufactured product 12 depending on the determined state of the manufactured product 12.

A preferred embodiment for manufacturing relates to autonomously (dis-) assemble certain objects by robotics. State can be determined depending on sensors. Preferably, for assembling objects the state characterizes the robotic manipulator itself and the objects that should be manipulated.

For the robotic manipulator, the state can consist of its joint angles and angular velocities as well as the position and orientation of its end-effector. This information can be measured by angle encoders in the joints as well as gyroscopes that measure the angular rates of the robot joints. From the kinematic equations, it is possible to deduct the end-effectors position and orientation. Instead, it is also possible to utilize camera images or lidar scans to infer the relative position and orientation to the robotic manipulator. The reward signal for a robotic task could be for example split into various stages of the assembly process. For example when inserting a peg into a hole during the assembly, a suitable reward signal would be to encode the peg's position and orientation relative to the hole. Typically, robotic systems are actuated via electrical motors at each joint. Depending on the implementation, the actions of the learning algorithms could therefore be either the needed torques or directly the voltage/current applied to the motors.

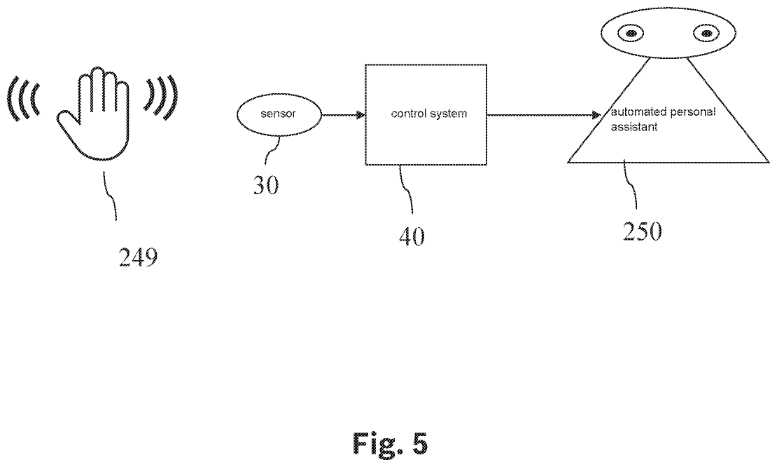

Shown in FIG. 5 is an embodiment in which control system 40 is used for controlling an automated personal assistant 250. Sensor 30 may be an optic sensor, e.g. for receiving video images of a gestures of user 249. Alternatively, sensor 30 may also be an audio sensor e.g. for receiving a voice command of user 249.

Control system 40 then determines actuator control commands A for controlling the automated personal assistant 250. The actuator control commands A are determined in accordance with sensor signal S of sensor 30. Sensor signal S is transmitted to the control system 40. For example, policy 60 may be configured to e.g. determine an action depending on the state characterizing a gesture recognition, which can be determined by an algorithm to identify a gesture made by user 249. Control system 40 may then determine an actuator control command A for transmission to the automated personal assistant 250. It then transmits said actuator control command A to the automated personal assistant 250.

For example, actuator control command A may be determined in accordance with the identified user gesture recognized by classifier 60. It may then comprise information that causes the automated personal assistant 250 to retrieve information from a database and output this retrieved information in a form suitable for reception by user 249.

In further embodiments, it may be envisioned that instead of the automated personal assistant 250, control system 40 controls a domestic appliance (not shown) controlled in accordance with the identified user gesture. The domestic appliance may be a washing machine, a stove, an oven, a microwave or a dishwasher.

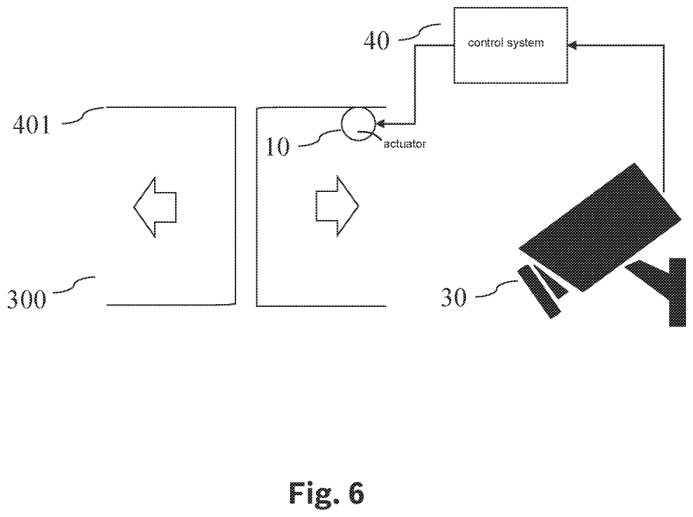

Shown in FIG. 6 is an embodiment in which control system controls an access control system 300. Access control system may be designed to physically control access. It may, for example, comprise a door 401. Sensor 30 is configured to detect a scene that is relevant for deciding whether access is to be granted or not. It may for example be an optical sensor for providing image or video data, for detecting a person's face.

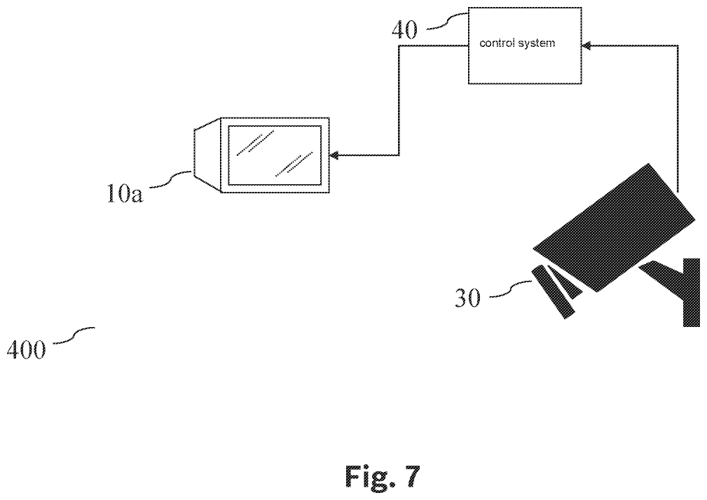

Shown in FIG. 7 is an embodiment in which control system 40 controls a surveillance system 400. This embodiment is largely identical to the embodiment shown in FIG. 5. Therefore, only the differing aspects will be described in detail. Sensor 30 is configured to detect a scene that is under surveillance. Control system does not necessarily control an actuator 10, but a display 10a. For example, the machine learning system 60 may determine a classification of a scene, e.g. whether the scene detected by optical sensor 30 is suspicious. Actuator control signal A which is transmitted to display 10a may then e.g. be configured to cause display 10a to adjust the displayed content dependent on the determined classification, e.g. to highlight an object that is deemed suspicious by machine learning system 60.

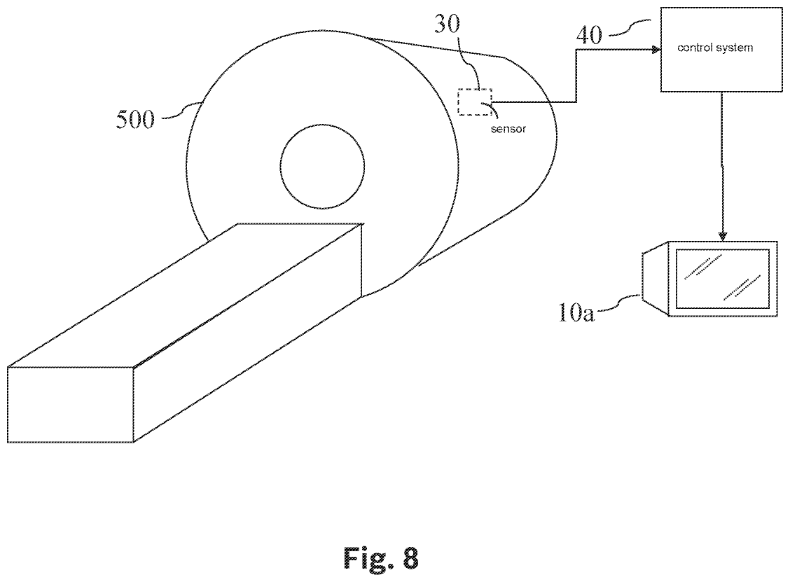

Shown in FIG. 8 is an embodiment of a control system 40 for controlling an imaging system 500, for example an MRI apparatus, x-ray imaging apparatus or ultrasonic imaging apparatus. Sensor 30 may, for example, be an imaging sensor. Policy 60 may then determine based on its input state an action characterizing a trajectory to take a recording of the imaging system 500.

The term “computer” covers any device for the processing of pre-defined calculation instructions. These calculation instructions can be in the form of software, or in the form of hardware, or also in a mixed form of software and hardware.

It is further understood that the procedures cannot only be completely implemented in software as described. They can also be implemented in hardware, or in a mixed form of software and hardware.

What is claimed is:

1. A computer-implemented method of reinforcement learning of a policy for an agent, comprising the following steps:
receiving an initialized first neural network (Q_{(θ}_{^{q}}₎) utilized as Q-function or value-function, an initialized second neural network (g_{(θ}_{^{g}}₎), auxiliary parameters (A, B), and an initialized policy (π);
repeating the following steps until a termination condition is fulfilled:
sampling a plurality of pairs (s,a,r,s′) of states (s), actions (a), rewards (r) and new states (s′) from a storage;
sampling first actions (ã˜π_{(θ)}(s)) for current states by the policy (π), and second actions (ã′˜π_{(θ)}(s′)) for the new sampled states by the policy;
computing features (ϕ←Q_{θ}_{^{Q}}(s, a), ϕ′←Q_{θ}_{^{Q}}(s′, ã′)) from a penultimate layer of the first neural network based on the sampled states and actions;
updating the second neural network (g_{(θ}_{^{g}}₎) and the auxiliary parameters (A, B) as follows:
$${θ}_{t}^{g} ← {θ}_{t - 1}^{g} - {η}_{g} {∇}_{{θ}^{g}} {L}_{g} ( s , {s}^{′} )$$
$${A}_{t} ← {A}_{t - 1} - {η}_{A} {∇}_{A} {L}_{A , B} ( s , {s}^{′} )$$
$${B}_{t} ← {B}_{t - 1} - {η}_{B} {∇}_{B} {L}_{A , B} ( s , {s}^{′} )$$
wherein L_{g} is given as follows:
$${L}_{g} = {{E}_{( s , a , r , {s}^{′} ) ∼ 𝒟 , {a}^{′} ∼ π ( {s}^{′} )} ( {g}_{θ} ( s , a ) - [ {\vert {A}^{⊤} ϕ ( s , a ) \vert}_{2}^{2} + {\vert {B}^{⊤} ϕ ( s ) \vert}_{2}^{2} + 2 {( {B}^{⊤} ϕ ( s ) )}^{⊤} {A}^{⊤} ϕ ( {s}^{′} , {a}^{′} ) ] )}^{2}$$
and L_{A,B} is given as follows:
$${L}_{A , B} = {E}_{( s , a , r , {s}^{′} ) ∼ 𝒟 , {a}^{′} ∼ π ( {s}^{′} )} exp ( {g}_{θ} ( s , a ) ) ( {\vert {( A + B )}^{⊤} ϕ ( s ) \vert}_{2}^{2} -$$
$$trace ( 2 {B}^{⊤} ϕ ( s , a ) {( ϕ ( s , a ) - ϕ ( {s}^{′} , {a}^{′} ) )}^{⊤} A ) ) ;$$
updating parameters (θ_{Q}) of the first neural network using a re-weighted loss (L_{Q}), wherein the loss (L_{Q}) is weighed by an exponential function applied to an output of second neural network (g_{θ}_{^{g}}(s, a)) for sampled state and action; and
updating parameters (θ_{π}) of the policy, wherein the updating is carried out by a Soft Actor Critic (SAC)-style loss.

2. The method according to claim 1, wherein the first neural network calculates a Q-function (Q_{(θ}_{^{q}}₎) or a value-function, wherein the step of updating the parameters (θ^{Q}) of the first neural network using the re-weighted loss (L_{Q}) is carried out as follows:
$${θ}_{t}^{Q} ← {θ}_{t - 1}^{Q} - {η}_{Q} exp ( {g}_{{θ}^{g}} ( s , a ) ) {∇}_{{θ}^{Q}} {{L}_{Q} ( {θ}^{Q} )}_{,}$$
wherein the step of updating the parameters (θ_{π}) of the policy is carried out as follows:
$${θ}_{t}^{π} ← {θ}_{t - 1}^{π} - {η}_{π} {∇}_{π} [ {Q}_{{θ}^{Q}} ( s , \tilde{a} ) - log {π}_{{θ}^{π}} ( \tilde{a} \vert s ) ] .$$

3. The method according to claim 1, wherein a Conservative Q-Learning Regularization to the Q-learning updates is applied.

4. The method according to claim 1, wherein the auxiliary parameters (A, B) are given by a k×m matrix, wherein k is a number of features of the penultimate layer of the first neural network, and wherein m is a number between 3 to 5, or m equals at the most 2k.

5. A computer-implemented method for operating an agent depending on a learned policy obtained by:
receiving an initialized first neural network (Q_{(θ}_{^{q}}₎) utilized as Q-function or value-function, an initialized second neural network (g_{(θ}_{^{g}}₎), auxiliary parameters (A, B), and an initialized policy (π);
repeating the following steps until a termination condition is fulfilled:
sampling a plurality of pairs (s,a,r,s′) of states (s), actions (a), rewards (r) and new states (s′) from a storage;
sampling first actions (ã˜π_{(θ)}(s)) for current states by the policy (π), and second actions (ã′˜π_{(θ)}(s′)) for the new sampled states by the policy;
computing features (ϕ←Q_{θ}_{^{Q}}(s, a), ϕ′←Q_{θ}_{^{Q}}(s′, ã′)) from a penultimate layer of the first neural network based on the sampled states and actions;
updating the second neural network (g_{(θ}_{^{g}}₎) and the auxiliary parameters (A, B) as follows:
$${θ}_{t}^{g} ← {θ}_{t - 1}^{g} - {η}_{g} {∇}_{{θ}^{g}} {L}_{g} ( s , {s}^{′} )$$
$${A}_{t} ← {A}_{t - 1} - {η}_{A} {∇}_{A} {L}_{A , B} ( s , {s}^{′} )$$
$${B}_{t} ← {B}_{t - 1} - {η}_{B} {∇}_{B} {L}_{A , B} ( s , {s}^{′} )$$
wherein L_{g} is given as follows:
$${L}_{g} = {{E}_{( s , a , r , {s}^{′} ) ∼ 𝒟 , {a}^{′} ∼ π ( {s}^{′} )} ( {g}_{θ} ( s , a ) - [ {\vert {A}^{⊤} ϕ ( s , a ) \vert}_{2}^{2} + {\vert {B}^{⊤} ϕ ( s ) \vert}_{2}^{2} + 2 {( {B}^{⊤} ϕ ( s ) )}^{⊤} {A}^{⊤} ϕ ( {s}^{′} , {a}^{′} ) ] )}^{2}$$
and L_{A,B} is given as follows:
$${L}_{A , B} = {E}_{( s , a , r , {s}^{′} ) ∼ 𝒟 , {a}^{′} ∼ π ( {s}^{′} )} exp ( {g}_{θ} ( s , a ) ) ( {\vert {( A + B )}^{⊤} ϕ ( s ) \vert}_{2}^{2} -$$
$$trace ( 2 {B}^{⊤} ϕ ( s , a ) {( ϕ ( s , a ) - ϕ ( {s}^{′} , {a}^{′} ) )}^{⊤} A ) ) ;$$
updating parameters (θ^{Q}) of the first neural network using a re-weighted loss (L_{Q}), wherein the loss (L_{Q}) is weighed by an exponential function applied to an output of second neural network (g_{θ}_{^{g}}(s, a)) for sampled state and action; and
updating parameters (θ^{π}) of the policy, wherein the updating is carried out by a Soft Actor Critic (SAC)-style loss;
wherein a sensor senses an environment of the agent and wherein a current state is determined depending on the sensed environment and wherein the learned policy determines an action (aₜ) for the agent depending on the current state, and wherein the agent carries out the action.

6. The method according to claim 5, wherein the agent is an at least partially autonomous robot and/or a manufacturing machine and/or an access control system.

7. A non-transitory machine-readable storage medium on which is stored a computer program for reinforcement learning of a policy for an agent, the computer program, when executed by a processor, causing the processor to perform the following steps:
receiving an initialized first neural network (Q_{(θ}_{^{q}}₎) utilized as Q-function or value-function, an initialized second neural network (g_{(θ}_{^{g}}₎), auxiliary parameters (A, B), and an initialized policy (π);
repeating the following steps until a termination condition is fulfilled:
sampling a plurality of pairs (s,a,r,s′) of states (s), actions (a), rewards (r) and new states (s′) from a storage;
sampling first actions (ã˜π_{(θ)}(s)) for current states by the policy (π), and second actions (ã′˜π_{(θ)}(s′)) for the new sampled states by the policy;
computing features (ϕ←Q_{θ}_{^{Q}}(s, a), ϕ′←Q_{θ}_{^{Q}}(s′, ã′)) from a penultimate layer of the first neural network based on the sampled states and actions;
updating the second neural network (g_{(θ}_{^{g}}₎) and the auxiliary parameters (A, B) as follows:
$${θ}_{t}^{g} ← {θ}_{t - 1}^{g} - {η}_{g} {∇}_{{θ}^{g}} {L}_{g} ( s , {s}^{′} )$$
$${A}_{t} ← {A}_{t - 1} - {η}_{A} {∇}_{A} {L}_{A , B} ( s , {s}^{′} )$$
$${B}_{t} ← {B}_{t - 1} - {η}_{B} {∇}_{B} {L}_{A , B} ( s , {s}^{′} )$$
wherein L_{g} is given as follows:
$${L}_{g} = {{E}_{( s , a , r , {s}^{′} ) ∼ 𝒟 , {a}^{′} ∼ π ( {s}^{′} )} ( {g}_{θ} ( s , a ) - [ {\vert {A}^{⊤} ϕ ( s , a ) \vert}_{2}^{2} + {\vert {B}^{⊤} ϕ ( s ) \vert}_{2}^{2} + 2 {( {B}^{⊤} ϕ ( s ) )}^{⊤} {A}^{⊤} ϕ ( {s}^{′} , {a}^{′} ) ] )}^{2}$$
and L_{A,B} is given as follows:
$${L}_{A , B} = {E}_{( s , a , r , {s}^{′} ) ∼ 𝒟 , {a}^{′} ∼ π ( {s}^{′} )} exp ( {g}_{θ} ( s , a ) ) ( {\vert {( A + B )}^{⊤} ϕ ( s ) \vert}_{2}^{2} -$$
$$trace ( 2 {B}^{⊤} ϕ ( s , a ) {( ϕ ( s , a ) - ϕ ( {s}^{′} , {a}^{′} ) )}^{⊤} A ) ) ;$$
updating parameters (θ^{Q}) of the first neural network using a re-weighted loss (L_{Q}), wherein the loss (L_{Q}) is weighed by an exponential function applied to an output of second neural network (g_{θ}_{^{g}}(s, a)) for sampled state and action; and
updating parameters (θ^{π}) of the policy, wherein the updating is carried out by a Soft Actor Critic (SAC)-style loss.

8. A control system for operating an actuator, the control system comprising:
a policy trained by reinforcement learning including:
receiving an initialized first neural network (Q_{(θ}_{^{q}}₎) utilized as Q-function or value-function, an initialized second neural network (g_{(θ}_{^{g}}₎), auxiliary parameters (A, B), and an initialized policy (π), repeating the following steps until a termination condition is fulfilled:
sampling a plurality of pairs (s,a,r,s′) of states (s), actions (a), rewards (r) and new states (s′) from a storage,
sampling first actions (ã˜π_{(θ)}(s)) for current states by the policy (T), and second actions (ã′˜π_{(θ)}(s′)) for the new sampled states by the policy,
computing features (ϕ←Q_{θ}_{^{Q}}(s, a), ϕ′←Q_{θ}_{^{Q}}(s′,ã′)) from a penultimate layer of the first neural network based on the sampled states and actions,
updating the second neural network (g_{(θ}_{^{g}}₎) and the auxiliary parameters (A, B) as follows:
$${θ}_{t}^{g} ← {θ}_{t - 1}^{g} - {η}_{g} {∇}_{{θ}^{g}} {L}_{g} ( s , {s}^{′} )$$
$${A}_{t} ← {A}_{t - 1} - {η}_{A} {∇}_{A} {L}_{A , B} ( s , {s}^{′} )$$
$${B}_{t} ← {B}_{t - 1} - {η}_{B} {∇}_{B} {L}_{A , B} ( s , {s}^{′} )$$
wherein L_{g} is given as follows:
$${L}_{g} = {{E}_{( s , a , r , {s}^{′} ) ∼ 𝒟 , {a}^{′} ∼ π ( {s}^{′} )} ( {g}_{θ} ( s , a ) - [ {\vert {A}^{⊤} ϕ ( s , a ) \vert}_{2}^{2} + {\vert {B}^{⊤} ϕ ( s ) \vert}_{2}^{2} + 2 {( {B}^{⊤} ϕ ( s ) )}^{⊤} {A}^{⊤} ϕ ( {s}^{′} , {a}^{′} ) ] )}^{2}$$
and L_{A,B} is given as follows:
$${L}_{A , B} = {E}_{( s , a , r , {s}^{′} ) ∼ 𝒟 , {a}^{′} ∼ π ( {s}^{′} )} exp ( {g}_{θ} ( s , a ) ) ( {\vert {( A + B )}^{⊤} ϕ ( s ) \vert}_{2}^{2} -$$
$$trace ( 2 {B}^{⊤} ϕ ( s , a ) {( ϕ ( s , a ) - ϕ ( {s}^{′} , {a}^{′} ) )}^{⊤} A ) ) ;$$
updating parameters (θ^{Q}) of the first neural network using a re-weighted loss (L_{Q}), wherein the loss (L_{Q}) is weighed by an exponential function applied to an output of second neural network (g_{θ}_{^{g}}(s, a)) for sampled state and action, and
updating parameters (θ^{π}) of the policy, wherein the updating is carried out by a Soft Actor Critic (SAC)-style loss;
wherein the control system is configured to operate the actuator in accordance with an output of the trained policy.
